(19) United States
(12) Patent Application Publication
(10) Pub. No.: US 2019/0225151 A1
(43) Pub. Date: Jul. 25, 2019

(54) VEHICLE REAR LIGHTS OPERATIONAL INDICATOR

(71) Applicants: Oliver Archibald Warlock, Lasalle (CA); Emily Lucille Warlock, Lasalle (CA)

(72) Inventors: Oliver Archibald Warlock, Lasalle (CA); Emily Lucille Warlock, Lasalle (CA)

(21) Appl. No.: 16/253,156

(22) Filed: Jan. 21, 2019

Related U.S. Application Data
(60) Provisional application No. 62/619,867, filed on Jan. 21, 2018.

(51) Int. Cl. B60Q 11/00

(52) U.S. Cl. CPC B60Q 11/005; B60Q 1/30

(57) ABSTRACT

An apparatus for monitoring a vehicle rear brake light, rear turn signal, and rear tail light. Sensors are placed in series of existing circuits of corresponding vehicle rear lights and communicate to a receiver the status of a rear light. If a rear light has expired, an LED indicator located on the receiver will shine Red. If the LEDs are displaying blue, then the receiver has power but is not connected to the sensor. If an LED is displaying green, the device has determined that a corresponding light bulb of a vehicle is correctly working.

### CROSS-REFERENCE TO RELATED APPLICATION

The present application is related to and claims priority from prior provisional application Ser. No. 62/619867, filed Jan. 21, 2018 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of vehicle indicator systems and more specifically relates to a vehicle taillight functional operations indicator having multiple indicator lights providing a driver with visual indication of the functioning of their vehicles taillights.

### 2. Description of the Related Art

Anyone who has owned or driven in a vehicle over an extended period of time has experienced malfunction of a motor vehicles lighting system. It is usually obvious to a driver if the front turn signals or headlights go out, but not so obvious if the rear lighting and signaling devices are not working properly. Vehicles are conventionally not provided with sensors that alert a driver if their lighting systems are malfunctioning. As such, a means to provide a driver a way to monitor the functioning of their vehicles lighting systems is needed.

Various attempts have been made to solve problems found in vehicle indicator system art. Among these are found in: U.S. Pat. No. 3,144,561 to Farrell Christopher W; U.S. Pat. No. 8,851,727 to Daniel Theisen; and U.S. Pat. No. 8,069,548 to Thomas Howard Radgens. This prior art is representative of vehicle taillight indicators systems. None of the above inventions and patents, taken either singly or in combination, is seen to describe the invention as claimed. Thus, a need exists for a reliable vehicle rear lights operational indicator to avoid the above-mentioned problems.

### BRIEF SUMMARY OF THE INVENTION

In view of the foregoing disadvantages inherent in the known art, the present invention provides a novel light monitoring system. The general purpose of the present invention, which will be described subsequently in greater detail, is to provide a vehicle tail light, turn signal, and brake light monitoring system that readily provides indication to a driver if the lighting systems are malfunctioning. The features of the invention which are believed to be novel are particularly pointed out and distinctly claimed in the concluding portion of the specification. These and other features, aspects, and advantages of the present invention will become better understood with reference to the following drawings and detailed description.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a vehicle real lights operational indicator, constructed and operative according to the teachings of the present invention.

FIG. 1 shows a perspective view illustrating a vehicle real lights operational indicator according to an embodiment of the present invention.

FIG. 2 showing a perspective view of the passenger compartment of a vehicle having the vehicle real lights operational indicator according to an embodiment of the present invention.

FIG. 3 showing a rear view of a vehicle having the vehicle real lights operational indicator according to an embodiment of the present invention.

FIG. 4 showing a front view of the sensor of the vehicle real lights operational indicator according to an embodiment of the present invention.

FIG. 5 showing a rear view of the sensor of the vehicle real lights operational indicator according to an embodiment of the present invention.

FIG. 6 showing the receiver of the vehicle real lights operational indicator according to an embodiment of the present invention.

FIG. 7 showing a perspective view illustrating the front panel of the vehicle real lights operational indicator according to an embodiment of the present invention.

FIG. 8 showing a wiring diagram of the vehicle real lights operational indicator according to an embodiment of the present invention.

FIG. 9 showing a wiring diagram of the vehicle real lights operational indicator according to an embodiment of the present invention.

FIG. 10 showing a wiring diagram of the vehicle real lights operational indicator according to an embodiment of the present invention.

FIG. 11 showing a wiring diagram of the vehicle real lights operational indicator according to an embodiment of the present invention.

FIG. 12 showing a wiring diagram of the vehicle real lights operational indicator according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a vehicle taillight indicators system and more particularly to a vehicle rear lights operational indicator 1.

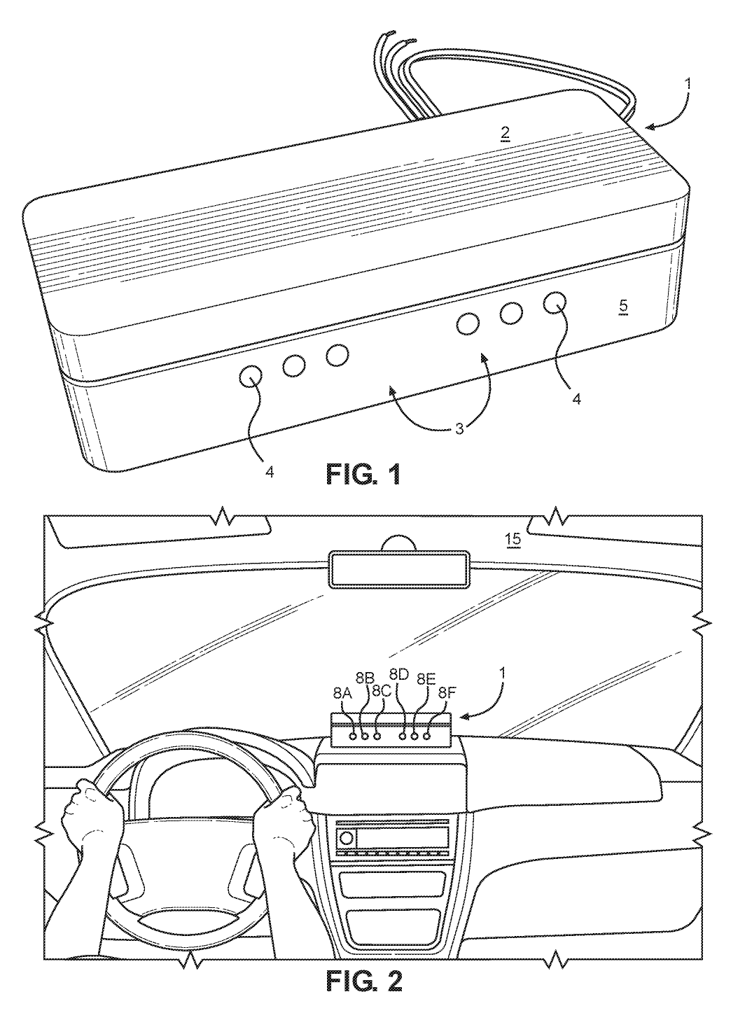

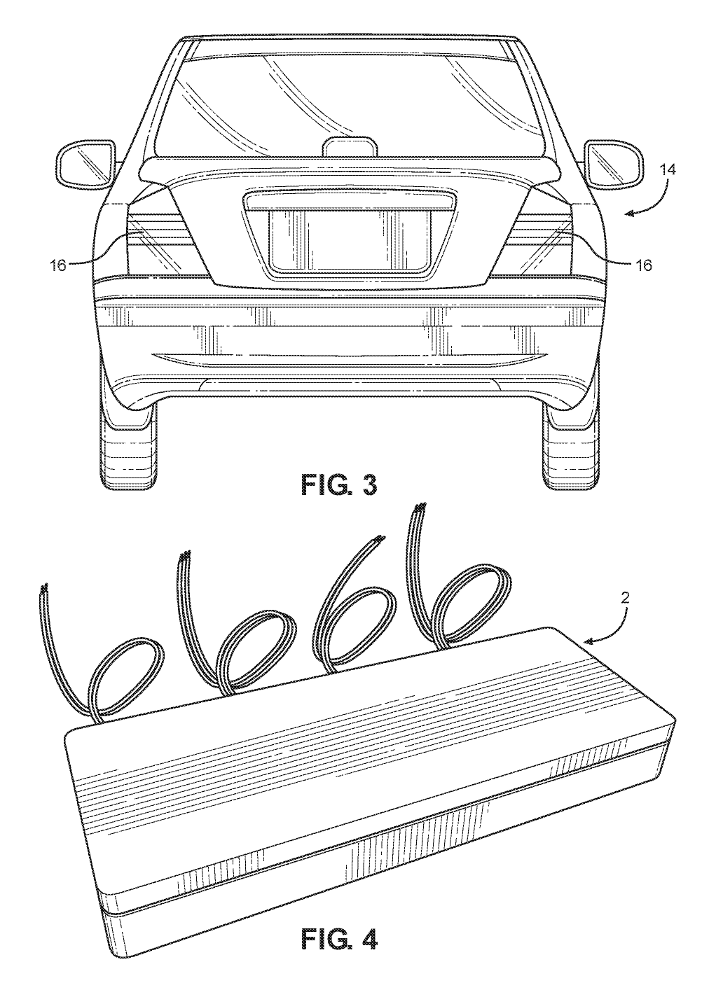

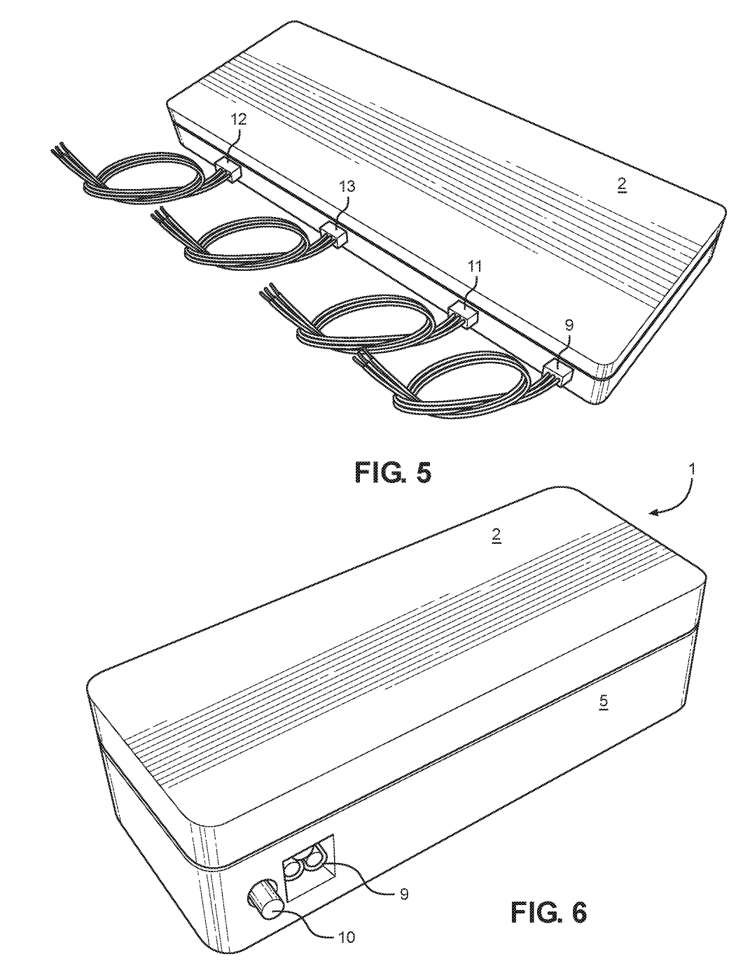

Referring to the drawings by numerals of reference there is shown in FIG. 1-12, the present invention comprises a vehicle rear lights operational indicator 1. The vehicle rear light operational indicator 1 comprises a power source 6, at least one sensor 2, and a receiver 5.

The sensor 2 and receiver 5 work in tandem to provide an electronic signal to a visual interface 17 to alert a vehicle driver to the status of a vehicles rear indicator lights 16. The visual interface 17 is located on a front panel 4 of the receiver 5 and comprises two groups of three visual indicators 7A, 7B, 7C, 7D, 7E, 7F.

The visual indicators 7A-7F comprise six LEDs 8A, 8B, 8C, 8D, 8E, 8F which turn blue, green, or red. If the LEDs are displaying blue, then the receiver 5 has power but is not connected to the sensor 2. If an LED is displaying green, the device has determined that a corresponding light bulb of a vehicle's rear indicator lights 16 is correctly working. If an LED is red it indicates that the corresponding light bulb of a vehicle's rear indicator lights 16 has failed.

The rear indicator lights 16 of a vehicle include rear left/right tail lights 11, rear left/right turn signals 13, and rear left/right brake lights 12. The receiver 5 is located in the passenger compartment 15 of a vehicle 14 and comprises the six LED indicators 8A-8F corresponding to the previously noted rear indicator lights 16. The receiver 5 is located in the passenger compartment 15 of a vehicle 14 in the line of sight of the driver, or alternatively in another location within a vehicle 14.

The sensor 2 of the present invention is connected to an existing tail 11, brake 12, and turn signal 13 wiring in the rear of an existing vehicle 14 and is installed in a vehicle's trunk. The sensor 2 and receiver 5 establish a wireless network so that the sensor 2 can send data to the receiver 5, which will process the data and display the status of a vehicle's rear indicator lights 16 on the visual interface 17 of the receiver.

Furthermore, the receiver 5 connects to a 12-volt power source 6 and is positioned so that the LED indicators 8A-8F of the visual interface 17 are visible to a driver seated in a driver's seat. Power is hardwired to a vehicle's wiring harness, or alternatively is provided by a 12-volt cigarette lighter accessory plug.

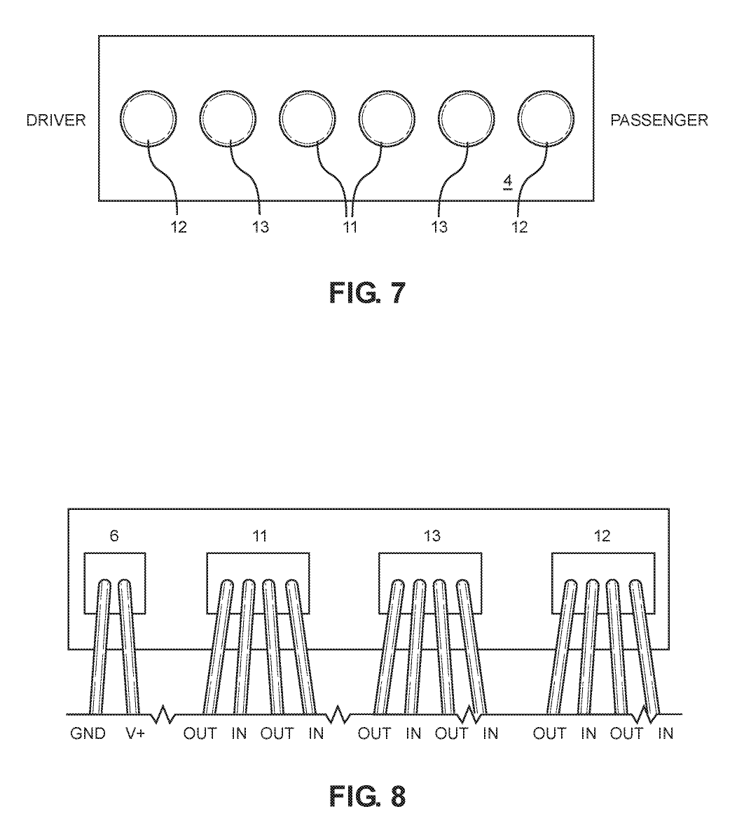

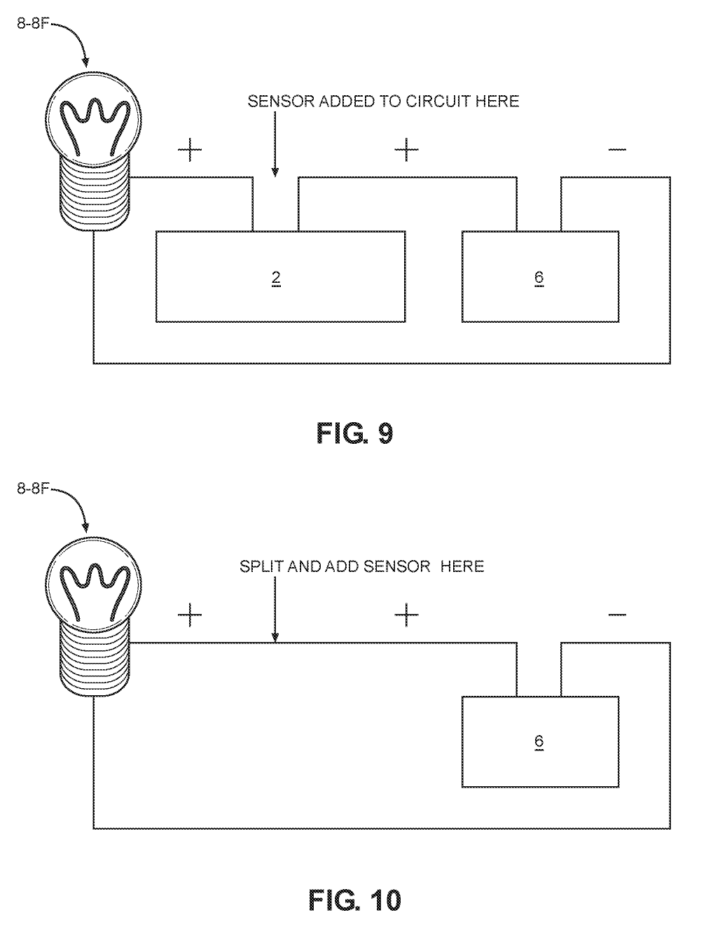

The sensor 2 has a 12-volt power source connected to a two-pin connector 9, red for positive and black for ground. Three 4-pin sensor connectors are provided with the sensor 2 and are each wired to the vehicles rear indicator lights 16, a rear driver's side turn/brake/tail lights, and a rear passenger's side turn/brake/tail light, as shown in FIG. 7. Connections to the turn/brake/tail lights of the sensor 2 are made by splitting the positive wires from the wiring harness to a vehicle's rear indicator light 16, and connecting the sensor in series there in-between, as shown in FIGS. 9-10.

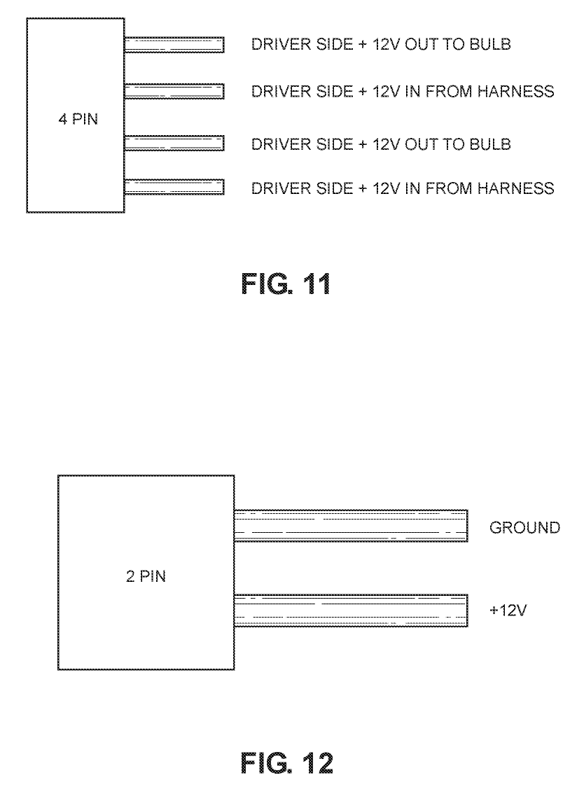

The sensor further comprises electronic connectors as follows: a 2-pin connector for power, a 4-pin connector for the tail lights, a 4-pin connector for the turn signal lights, and a 4-pin connector for the brake lights, as shown in FIGS. 11 and 12.

The sensor 2 reads the voltage across and the current used by a light circuit. If there is voltage but no current, the circuit has power but there is no load; this likely means that a bulb has failed. This will cause an LED on the receiver 5 to turn from green to red, indicating the status of a corresponding vehicles rear indicator light 16. If there is no voltage detected on a circuit then no current can be used so the corresponding LED on the receiver will remain green.

It may occasionally be necessary to restart the receiver 5 if it fails to connect after more than 30 seconds. In this case, a reset button 10 may be provided which is located on the back of the receiver 5. A user can depress the reset button 10 briefly to restart the receiver 5, so that the receiver 5 can attempt to connect to the sensor 2 again.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A vehicle rear lights operational indicator comprising:
a sensor;
wherein said sensor is adapted to be electrically connected between a visual display and the rear lights of a vehicle; and
wherein said sensor is adapted to determine the functional status of said rear lights;
a visual display including:
a front panel including:
a visual interface;
wherein said visual display is adapted to alert an operator of said vehicle to said functional status of said rear lights; and
a power source;
wherein said power source is electrically connected to said sensor and said visual display and is adapted to provide electric power thereto.

2. The vehicle rear light operational indicator of claim 1, wherein said visual interface includes a plurality of visual indicators.

3. The vehicle rear light operational indicator of claim 2, wherein said plurality of visual indicators includes two groups of three visual indicators.

4. The vehicle rear light operational indicator of claim 2, wherein said plurality of visual indicators includes light emitting diodes.

5. The vehicle rear light operational indicator of claim 4, wherein there are six light emitting diodes.

6. The vehicle rear light operational indicator of claim 4, wherein said light emitting diodes are adapted to emit a color chosen from a list of colors consisting of blue, green, or red.

7. The vehicle rear light operational indicator of claim 6, wherein said color blue is adapted to indicate that said receiver has power but is not connected to said sensor; wherein said color green is adapted to indicate that a corresponding light bulb of said vehicle's rear lights is working correctly; and wherein said color red is adapted to indicate that a corresponding light bulb of a vehicle's rear lights has failed.

8. The vehicle rear light operational indicator of claim 1, wherein said power source is a 12 volt power source.

9. A combination of a vehicle and a rear lights operational indicator, comprising:
a vehicle including:
a passenger compartment; and
rear lights; and
a rear lights operational indicator comprising:
a sensor;
wherein said sensor is adapted to be electrically connected between a visual display and said rear lights of said vehicle; and
wherein said sensor is adapted to determine the functional status of said rear lights;
a visual display including:
a front panel including:
a visual interface;
wherein said visual display is adapted to be located within said passenger compartment of said vehicle to alert an operator of said vehicle to said functional status of said rear lights; and
a power source;
wherein said power source is electrically connected to said sensor and said visual display and is adapted to provide electric power thereto.

10. The combination of claim 9, wherein said visual interface includes a plurality of visual indicators.

11. The combination of claim 10, wherein said plurality of visual indicators includes two groups of three visual indicators.

12. The combination of claim 10, wherein said plurality of visual indicators includes light emitting diodes.

13. The combination of claim 12, wherein there are six light emitting diodes.

14. The combination of claim 12, wherein said light emitting diodes are adapted to emit a color chosen from a list of colors consisting of blue, green, or red.

15. The combination of claim 14, wherein said color blue is adapted to indicate that said receiver has power but is not connected to said sensor; wherein said color green is adapted to indicate that a corresponding light bulb of said vehicle's rear lights is working correctly; and wherein said color red is adapted to indicate that a corresponding light bulb of a vehicle's rear lights has failed.

16. The combination of claim 9, wherein said power source is a 12 volt power source.

17. The vehicle rear light operational indicator of claim 9, wherein said rear lights of said vehicle includes rear left and right tail lights, rear left and right turn signals, and rear left and right brake lights.
